(19) United States
(12) Patent Application Publication
(10) Pub. No.: US 2008/0001944 A1
(43) Pub. Date: Jan. 3, 2008

(54) LOW POWER LCD SOURCE DRIVER

(75) Inventor: Yu-Jui Chang, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 11/770,065

(22) Filed: Jun. 28, 2007

Related U.S. Application Data
(63) Continuation-in-part of application No. 11/428,141, filed on Jun. 30, 2006.

(51) Int. Cl. G09G 5/00

(52) U.S. Cl. 345/214

(57) ABSTRACT

The invention provides solutions to solve the power consumption of the image data buses of an LCD source driver. With a bus buffer provided in one embodiment of the invention, a first image data buses are divided into several groups. Each group of image data buses is dispatched by the bus buffer. It is possible in one embodiment of the invention that some groups are active when the others are passive. Therefore, unnecessary power consumption is cut off. Despite the power saved by the management of the bus buffer, the parasitic capacitance of each group of image data buses is much smaller than that of the image data buses in the prior art. Moreover, the management of the bus buffer can depend upon the layout patterns or the layout locations of circuit components so that the driving strength of the bus buffer may be modified according to the layout pattern or the layout locations.

### APPLICATION FOR CLAIM OF PRIORITY

This application claims priority as a Continuation-In-Part under 35 U.S.C. §120 to U.S. patent application Ser. No. 11/428,141, filed Jun. 30, 2006 and entitled “Data Bus Power Down for Low Power LCD Source Driver.” The disclosure of the above identified application is incorporated herein by reference.

### BACKGROUND

I. Field of the Invention

The present invention generally relates to drive circuits for display devices such as liquid crystal display devices, and more particularly, certain embodiments of the invention relate to drive circuit devices that reduce power consumption.

II. Background of the Invention

As liquid crystal display devices continue to replace traditional CRT displays at an aggressive pace the improvements in drive circuit devices have also accelerated. A liquid crystal display (LCD) device can be an active-matrix type, which has a plurality of active elements arranged on a flat substrate, e.g., flat glass, in a matrix configuration. Unlike conventional passive-matrix type of LCDs, in which each pixel of the panel is driven by a plurality of conductive wires arranged in columns and rows, active-matrix type LCDs uses a tiny active element, like a TFT (thin film transistor) to direct flowing current and to apply control voltages.

Liquid crystal display devices employ a plurality of source and gate driver ICs for activating each basic display element on the flat panel. Thus, each element is either switched ON or OFF, such that light generated from a backlight CCFL (Cathode Cold Fluorescent Light) tube either passes through the display element or is blocked.

Normally, the purpose of a gate driver is to provide a series of scanning signals for each row of pixels. The scan frequency of a liquid crystal display device is 60 Hz which means images displayed on the screen are refreshed sixty times per second, which is fast enough that human eyes do not notice such changes. In a line sequential driving system, a scanning signal of only one row is active at a time. For example, when a scanning signal for a first row of pixels is active, the other scanning signals are passive. Then, a second scanning signal for a second row of pixels is activated and the other scanning signals, including the first one, are passive, and so forth.

The image data is supplied by source driver ICs. The outputs of the source driver ICs are supplied to the source terminals of the tiny active elements. Each tiny active element comprises a TFT which is a transistor, familiar to those skilled in the art, comprising source, drain and gate terminals. Current can pass the source terminal, through the body of the transistor and be outputted to the drain terminal when the gate terminal, controlled by the output of the gate driver mentioned above, contains an active voltage level. Usually, gamma voltages are provided to assist the source driver ICs to supply a precise voltage level to twist the liquid crystal molecules of a pixel. With the help of the gamma voltages, an image with complex colors can be shown on a flat display panel.

There is a huge amount of image data supplied from the source driver ICs to the display panel. Additionally, from time to time the image data increases further when a plurality of moving pictures are displayed within a short period of time or a high resolution image is illustrated on a large screen. In actuality, the burden of activating a display panel is borne mostly by the source driver ICs. Thus, the power consumption of the whole liquid crystal display device may be reduced by focusing on reducing power consumption of the source driver ICs.

As liquid crystal display panels are widely used as monitor screens for computers, and integrated into mobile devices, e.g., mobile phones and notebook computers, the battery life play an important role. Without long battery life, acceptance of mobile devices would decrease and the convenience of mobile devices would be diminished. Hence, the power consumption of source driver ICs constitutes a problem as liquid crystal display panels continue to become higher resolution and are embedded into mobile devices.

In U.S. Pat. Publication No. US2003/0048249 to Sekido et al. entitled “Drive circuit device for display device, and display device using the same,” a drive circuit device for a display device which drives a plurality of source bus lines provided on a display panel comprises a driver unit used to sequentially fetch data signals and generate drive signals for the source bus lines in accordance with the fetched data signals, a gate unit, after elapse of a specified time from the reception of the driver unit and a timing when a rear-stage drive circuit device starts receiving, starts outputting a propagation signal including a clock signal, data signal and control signals to the rear-stage drive circuit device. The disclosure of this reference is incorporated herein by reference as if set forth in full. Although the power consumption of each of the source driver ICs is saved according to the disclosure, the power consumption of the source driver ICs is still not reduced. The data buses inside the source driver ICs consume most of power.

In U.S. Pat. No. 6,008,801 to Jeong entitled “TFT LCD source driver,” a source driver circuit is disclosed to reduce power consumption by employing a first latch for latching a plurality of digital video signals, a second latch for outputting non-inverted and inverted digital video signals, a first multiplexer selecting a group of non-inverted or inverted digital video signals according to an odd polarity signal and an even polarity signal, a second multiplexer selecting digital video signals according to a dot inversion control signal and an output buffer comprising one or two voltage adders. The disclosure of this reference is incorporated herein by reference as if set forth in full. In this disclosure, the source driver uses only a low voltage D/A converter. Although this disclosure reduces the power consumption of the source driver ICs by utilizing at least one voltage adder to eliminate one D/A converter, it does not describe how to reduce the power consumption generated on the data bus of the digital video signals.

In U.S. Pat. No. 6,747,626 to Chiang entitled “Dual mode thin film transistor liquid crystal display source driver circuit,” a source driver that is able to provide several different operating modes for the driver to lower the power consumption of a TFT-LCD module while still providing a wide analog voltage range to the liquid crystal display elements, is disclosed. The disclosure of this reference is incorporated herein by reference as if set forth in full. An output cell is provided, in the disclosure, for supplying voltages at the outputs of the driver circuit when other components including internal resistive, digital to analog converters, decoder/output voltage drivers and output buffer amplifiers are powered down. Although extra output cells and latch circuits are applied in the disclosure, it does not describe a reduction of the power consumption on the data bus where lots of digital video signals are applied from external apparatus, e.g., computers.

As discussed above, the source driver ICs are burdened with most of the power consumption for displaying images on liquid crystal display panels due to line sequential driving systems that are utilized in most of modern LCD flat panels. The busy data transmission on the video data bus consumes a large portion of power.

### SUMMARY OF THE INVENTION

Apparatuses for driving a display device are disclosed.

In one aspect of the present invention is to provide a solution to reduce the data bus power consumption of source driver ICs. According to one embodiment of the invention, data buses for transmitting image data of the source driver circuit are divided into several segments controlled by at least one bus buffer. Thus, each segment of image data buses is shorter than the original image data buses. Each segment of image data buses has a smaller parasitic capacitance than in the prior art. The invention provides a source driver circuit comprising a plurality of shift registers having multiple outputs; a line buffer receiving a plurality of image buses and the outputs from the shift registers, and having multiple channel units and first multiple outputs; a D/A converter converting the outputs from the line buffer and having second multiple outputs; a buffer using the second outputs from the D/A converter as a reference and generating drive current; and wherein the line buffer contains at least one bus buffer receiving and dispatching the image data buses to channel units. Moreover, the image data buses might contain primary color information including red, green and blue. The bus buffer may comprise at least one multiplexer or at least one tri-state buffer.

In one aspect of the invention, a source driver circuit is disclosed, including: at least a bus buffer receiving a first plurality of image data buses, a second plurality of image data buses and a third plurality of image data buses coupled with the bus buffer, a plurality of channel units record image data from the second plurality of image data buses or the third plurality of image data buses, and a plurality of shift registers generating timing signals coupled with the channel units. Additionally, the source driver further comprises a control circuit outputting at least one enable signal to the bus buffer according to the timing signals.

In another aspect of the invention, a source driver circuit is disclosed, including: a plurality of shift registers having first multiple outputs, a line buffer receiving a first plurality of image data buses and the first outputs from the shift registers and having multiple channel units and second multiple outputs, a D/A converter converting the second outputs from the line buffer and having third multiple outputs, a buffer using the third outputs from the D/A converter as reference and generating drive current. The line buffer contains at least one bus buffer receiving and dispatching the first image data buses to channel units and the bus buffer dispatches the first image data buses into a second plurality of image data buses and a third plurality of image data buses.

### BRIEF DESCRIPTION OF THE DRAWINGS

For a more complete understanding of the principles disclosed herein, and the advantages thereof, reference is now made to the following descriptions taken in conjunction with the accompanying drawings, in which:

FIG. 1 shows a circuit architecture of a source driver IC, in accordance with one embodiment.

FIG. 2 illustrates a line buffer and a 128-bit bi-directional shift register of a source driver IC in the prior art.

FIG. 3A illustrates a line buffer and a 128-bit bi-directional shift register of a source driver IC, in accordance with one embodiment.

FIG. 3B illustrates a line buffer and a 128-bit bi-directional shift register of a source driver IC, in accordance with one embodiment.

FIG. 4 is a diagram illustrating shifting signals from the bi-directional shift registers and control signals to a bus buffer, in accordance with one embodiment.

FIG. 5 is an illustration of a source driver utilizing a control circuit to dispatch data signals, in accordance with one embodiment.

### DESCRIPTION OF EMBODIMENTS OF THE INVENTION

Apparatuses for driving a display device are disclosed. It will be clear, however, that the present invention may be practiced without some or all of these specific details. In other instances, well known process operations have not been described in detail in order not to unnecessarily obscure the present invention.

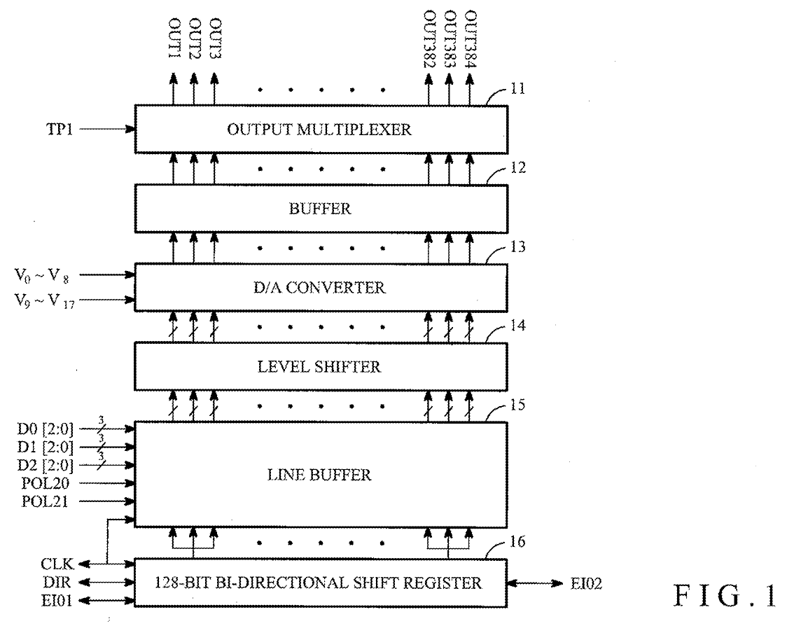

In FIG. 1, the architecture of a source driver IC is shown, in accordance with one embodiment. The source driver can have 384 channels and can include a 128-bit bi-directional shift register 16, a line buffer circuit 15, a level shifter circuit 14, a D/A converter circuit 13, a buffer circuit 12 and an output multiplexer circuit 11. In order to receive image data from the other circuit components, a clock signal CLK can be sent to the 128-bit bi-directional shift register 16 of the source driver. When the image data contains color information, more complicated signals like D0[2:0], D1[2:0] and D2[2:0] can be input into the line buffer circuit 15 of the source driver. In one embodiment, D0, D1 and D2 respectively represents color information of red, green and blue, each color using three bits to decode the data. Each of the color signals D0, D1 and D2 may include multiple image data bits (e.g., three bits of image data, six bits of image data, etc.) for illustrating an image with more complex colorful pixels supporting the display of colorful images on a monitor screen. Additionally, a multicolored monitor screen may also display gray levels of colors. A plurality of gamma voltages V0˜V8, V9˜V17 can be sent from other circuit components, e.g., gamma voltage circuit, into the D/A converter circuit 13 of the source driver.

The 128-bit bi-directional shift register 16 receives a clock signal CLK and a timing signal from either IO port EIO 1 or EIO 2 depending on the directional signal DIR. In one embodiment, the timing signal can be transmitted from the IO port EIO 1 and output from IO port EIO 2 to a next source driver IC. In another embodiment, the timing signal can be transmitted from the IO port EIO 2 and outputted from the IO port EIO 1 to a next source driver IC. Usually, a TFT flat panel utilizes a plurality of source driver ICs, which are arranged in series or connected in cascading fashion. The triggering timing signal can be input from one side or the other of the source drivers in cascading fashion. In one embodiment, one hundred and twenty eight outputs are sent out from the 128-bit bi-directional shift register 16 to the line buffer 15 for controlling the latching operation of color signals D0, D1 and D2. In another embodiment, the 128-bit bi-directional shift register 16 contains a plurality of bi-directional shift registers. A 128-bit unidirectional shift register can be employed in a source driver such that only one propagation direction for the timing signals is permissible. It should be appreciated that the 128-bit bi-directional shift register 16 described above is but one example of a 128-bit shift register 16 architecture and that other types or configurations of registers can also be used in other embodiments of the present invention. The specific number of 128-bit bi-directional shift registers 16 in FIG. 1 is provided here for illustrative purposes only and should not be used to limit the number of shift registers present in the various embodiments disclosed herein.

Line buffer 15 receives a plurality of timing signals sequentially in a time scale from the 128-bit bi-directional shift register 16. Typically, line buffer 15 includes a plurality of registers, e.g., latches or flip-flops, able to keep data temporarily. The line buffer receives color signals D0, D1 and D2, respectively, on different channels in a serial manner and outputs signals stored within the plurality of registers in parallel to a next stage for further processing. In one embodiment, color signals D0, D1 and D2 are from other circuit components. For example, the color signals may be transmitted from a computer, a timing controller or a graphic card. In another embodiment, the color signals D0, D1 and D2 form a data bus comprising a plurality of data signals connected to multiple registers of the line buffer 15 such that each of the registers of the line buffer 15 grasps the necessary color signals from the same data bus comprising color signals D0, D1 and D2. The sharing of data buses is a technique for saving layout area on an integrated circuit chip. The integrated circuit chip acquires timing signals from the 128-bit bi-directional shift register 16 to manage each register so that the data bus is shared for an appropriate time period. In a color source driver, each pixel of the color panel comprises at least a red, a green and a blue sub-pixel. In one embodiment, line buffer 15 can utilize a timing signal for three registers to latch one bus of D0, D1 and D2, respectively, so that one hundred and twenty eight timing signals can control three hundred and eighty four monochromatic pixels or one hundred and twenty eight chromatic pixels of the display panel. In FIG. 1, a clock signal CLK can trigger line buffer 15 to initiate a latching event. In addition, polarity signals POL20, POL21 are employed because liquid crystal display panels can use inversion methods to avoid damaging the pixels and DC (direct current) voltage accumulation. Examples of inversion methods that can be used include: line inversion, dot inversion and N-line inversion. It should be appreciated that other inversion methods can also be used as long as the permanent twist force and DC voltage accumulation can be controlled. A plurality of outputs containing color and polarity information for pixels can be further output for the next signal processing stage.

The level shifter 14 can be used to transfer the digital data which is output from line buffer 15 to other analog voltage levels that can control and communicate with the analog world, e.g., liquid crystal display panels. Typically, the level shifter 14 includes a plurality of level shifter components each of which might contain an inverter. When the input of the level shifter component is low, the output of the level shifter component can be connected to ground. The output of the level shifter component can be connected to a supplied voltage much higher or much lower than the normal power for digital logic circuits when the input of the level shifter component is set at digital logic high.

The D/A converter 13 actually receives digital data from line buffer 15. The digital data contains color and polarity information of the image data but transformed into analog form by level shifter 14. The color information of the digital data from line buffer 15 further contains gray levels for each pixel. The gray level information helps the D/A converter 13 to select one of a plurality of gamma voltages V0˜V17 so that each pixel can display a color with an appropriate gray level. It should be noted that a color image shown on a LCD screen may contain three primary colors and a plurality of gray levels. Each selected gamma voltage can be further sent out to a next stage such that precise color information and strong driving force can be provided by the source driver to the liquid crystal display panel.

Buffer 12 is an interface configured to receive the selected gamma voltage from each pixel to provide enough current driving ability to the liquid crystal display elements, e.g., liquid crystal display pixels. The display panel can display correct color information without creating distortions or flickers when it receives sufficient current from the D/A converter 13. Buffer 12 is includes a plurality of source followers. A source follower can be implemented by a single transistor. Usually, a plurality of unit gain operational amplifiers are employed in buffer 12 such that the output voltage can reach the original inputted gamma voltage without deduction of voltage.

Output multiplexer 11 is usually synchronized by a TP1 signal in a line sequential driving system. In a line sequential driving system, each line of the driving system is comprised of a plurality of pixels in row. These pixels are not changed until the completion of the previous scanning signal. Generally, every pixel arranged in a horizontal line should be ready before the trigger of a TP 1 signal. There are other advantages to using the output multiplexer 11. When the display controller is powered down into low power mode, the output multiplexer 11 may be switched to another regulator to supply the panel with current so that an image can still be displayed on the screen even when the controller is operating in low power mode. In this way, other components like line buffer 15 and level shifter 14 can be switched into low power mode with little power consumption. A plurality of outputs, e.g., OUT 1˜384, can be sent out from the output multiplexer 11 to display pixels on the liquid crystal display panel.

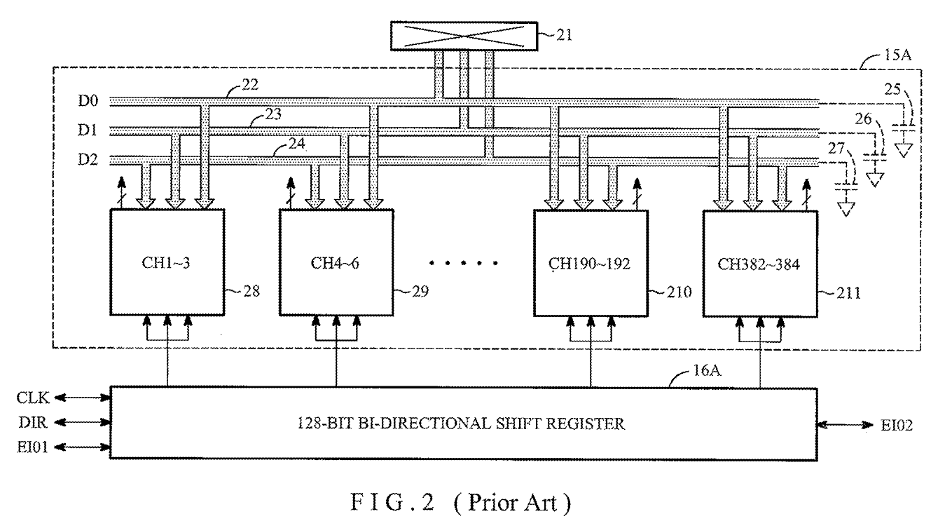

To better illustrate the advantages and benefits of the various embodiments of the present invention, a description of an example of a line buffer 15 in the prior art is provided here in FIG. 2. A 128 bi-directional shift register 16A of a source driver IC can provide one hundred and twenty eight outputs according to a clock signal CLK, 10 port EIO 1 and a direction control signal DIR. The 128 bi-directional shift register 16A comprises IO port EIO 2 when cascading multiple source driver ICs in serial are needed. A more detailed drawing of line buffer 15A is provided herein. The IO port EIO 1 receives timing signals and outputs pulses of latch timing signals for channel units 28˜29, 210˜211 of line buffer 15A. Here, channel unit 28 is comprised of three channels 1˜3 and latches image data onto data buses D0 22, D1 23 and D2 24 according to one timing signal from the 128 bi-directional shift register 16A This one timing signal controls the three channels comprising channel unit 28. The other channel units 29, 210 and 211 are similar to channel unit 28. It should be understood that although only four channel units (i.e., 28, 29, 210 and 211) are shown in FIG. 2, line buffer 15A can include other channel units that are similar to those four channel units. An input pad circuit 21 of the source driver IC is configured to accept color signals via data bus D0 22, data bus D1 23 and data bus D2 24. Each of the data buses can be shared by all the channel units. As such, this configuration may create power consumption problems.

Each data bus can contain a metal line forming a capacitive load corresponding to the substrate of the silicon chip or ground. A lumped capacitor 25 drawn and coupled with data bus D0 22 shows the total capacitive effect of all the metal lines of data bus D0 22. Capacitor 26 is drawn and coupled with the data bus D1 23 to show the total capacitive effect of all the metal lines of data bus D1 23. Capacitor 27 is drawn and coupled with data bus D2 24 to show the total capacitive effect of all the metal lines of the data bus D2 24. Power consumption of a capacitor is described in the following equation:

$$p = \frac{1}{2} {fcv}^{2}$$

p represents the power consumption of signals on the metal lines, f is the frequency of the signals, c is the capacitive loading on the metal lines, and v is the supplied voltage of signals applied on the metal lines.

Reducing the supplied voltage may significantly impact power consumption. However, it is not easy to achieve this goal without further advancements in semiconductor technology. Slowing down the operating frequency can also lower the power consumed on the metal lines. However, this might downgrade the performance of other functions.

Parasitic capacitance is caused by long metal lines and is a concern that affects the performance of data transmitted on the data buses. Parasitic capacitance can be conceptualized as a plurality of small resistors connected in series such that the voltage level of input signal drops along the metal lines. The voltage level may drop under the threshold voltage of circuit devices so that information embedded in the data transmissions disappears or drops to a level that is sensitive to noise on the silicon chip such that the data becomes inaccurate.

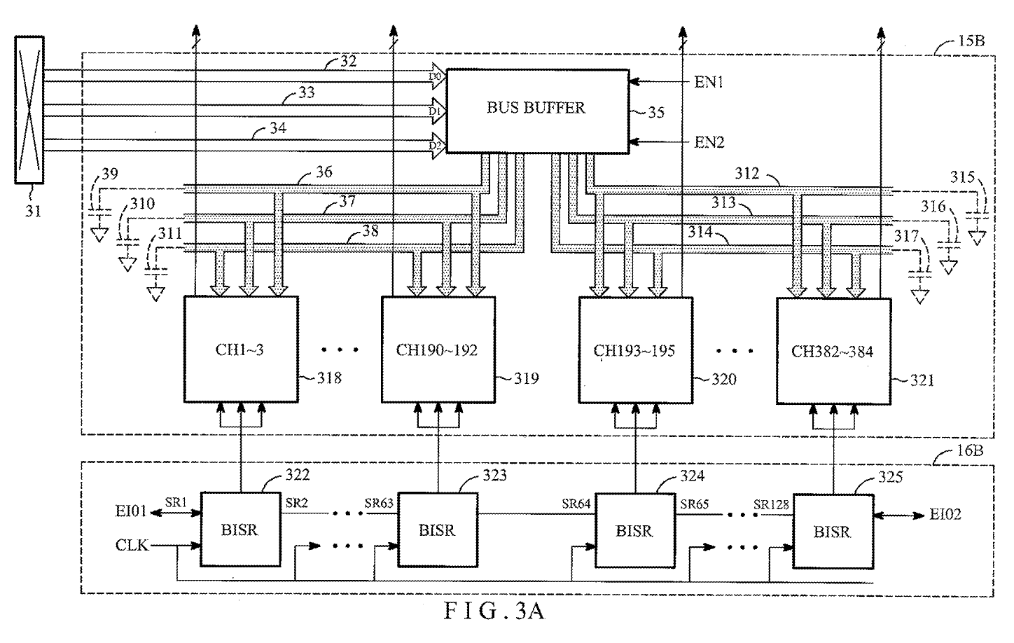

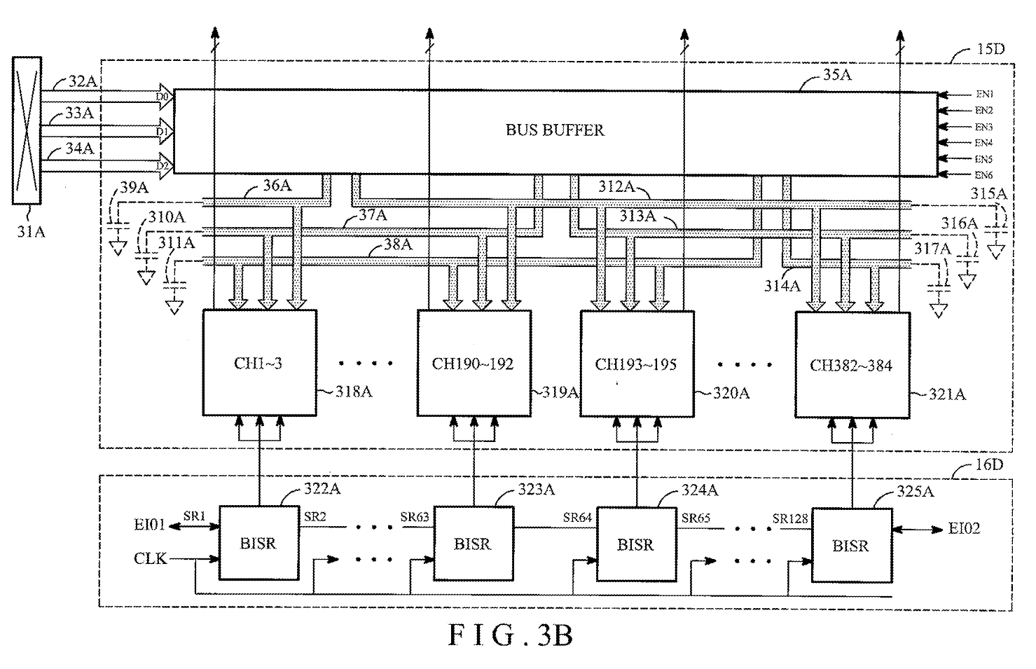

Therefore, in one embodiment of the present invention, as disclosed in FIG. 3A, a source driver is shown including: a 128 bi-directional shift register 16B, a plurality of channel units 318˜321, a plurality of data buses 36˜38, 312˜314 and a bus buffer 35. The source driver further comprises an input pad circuit 31 configured to accept color signals from an external source (e.g., a computer interface, a timing controller or a graphic card, etc.) transport those signals to the source driver via data bus D0 32, data bus D1 33 and data bus D2 34. With the dispatching of the bus buffer 35, each group of channel units receives image data from at least one specific data bus depending upon the dispatching of the bus buffer 35. In this way, the power consumed by the toggles of signals on the data bus is significantly reduced.

The 128 bi-directional shift register 16B is comprised of a plurality of bi-directional shift registers 322˜325 each triggered by a clock signal CLK. A timing signal can be input from either IO port EIO 1(SR1) or IO port EIO 2. Examples of bi-directional shift registers include, but are not limited to flip flops, latches, etc. After receiving the timing signal, the bi-directional shift register 322 can pass timing signal SR2 to the next bi-directional shift register (not shown) in cascade. In one embodiment, the bi-directional shift registers can be replaced by unidirectional shift registers if the source driver is not required to be bi-directional. In FIG. 3A, bi-directional shift register 323 and bi-directional shift register 324 are shown to receive timing signal SR63 and SR64, respectively, for illustrative purposes only and should not be interpreted to limit the number and types of registers that can included with the various embodiments of this invention. In certain embodiments, there can be arbitrary groupings of channel units. Here, bi-directional shift register 324 can output timing signal SR65 to the next bi-directional shift register (not shown), and bi-directional shift register 325 can receive timing signal SR128 and drive out signals to IO port EIO 2 if there are other source driver ICs in the series.

Line buffer 15B includes: channel units (318˜321), data buses (D0 32, D1 33 and D2 34), bus buffer 35 and the plurality of data buses (36˜38 and 312˜314). Line buffer 15B can serve the same function as line buffer 15 in FIG. 1. The channel units 318˜321 record their own image data from data buses 36˜38 and 312˜314 once triggered by the sequential outputs of the bi-directional shift registers. Channel units 318˜321 further outputs recorded image data to level shifter 14 in FIG. 1. Bus buffer 35 is configured to group original image data buses D0 32, D1 33, and D2 34 into a first group of image data buses 36˜38 and a second group of image data buses 312˜314. The first group of image data buses 36˜38 are dispatched to transmit data to channel units 318 and 319; while the second group of image data buses 312˜314 are dispatched to transmit data to channel units 320 and 321. Channel units 318-321 are shown in FIG. 3A for illustrative purposes only. It should be understood that the groupings of image data buses (36˜38 and 312˜314) can be dispatched to channel units that have up to one hundred and ninety two channels.

The management of the dispatching of bus buffer 35 is controlled by two enable signals (EN1 and EN2). When enable signal EN1 is active, the image data on data buses D0 32, D1 33, and D2 34 can be dispatched to image data buses 36˜38. Meanwhile, image data buses 312˜314 can be forced to be passive. In one embodiment, when enable signal EN2 is active the image data on data buses D0 32, D1 33, and D4 34 are dispatched to image data buses 312˜314. Meanwhile, image data buses 36˜38 are forced to be passive. Capacitors 39, 310 and 311 represents the parasitic capacitance created by the metal lines of data buses 36˜38. Capacitors 315˜317 represents the parasitic capacitance created by the metal lines of data buses 312˜314. Since the data buses are essentially divided into two groups, the length of the metal lines can also be divided into separate segments, each of which, comprises about half the capacitance created by each of the parasitic capacitors 25˜27 in FIG. 2. According to the power calculation, discussed above, the power consumption can be reduced by about half. With the bus buffer, the transmission voltage level can be maintained without being reduced due to the parasitic resistance of the metal lines. As such, there is not much voltage drop throughout the bus line, immunity against noise can be achieved and there can be a reduction of capacitive loading of the channel units. Each channel unit can contain a plurality of channels comprising the logic circuits. Since the number of channels can be substantial, the gate capacitance of the logic circuits of the channels should not be ignored. Hence, the power consumption on the data buses may be further lowered.

Bus buffer 35 can be implemented by a multiplexer or tri-state buffer whose select signals are connected to enable signals EN1 and EN2. Bus buffer 35 can be implemented by simple logic circuits, e.g., NAND logic circuits, NOR circuits, inverters, etc. Moreover, the enable signals EN1 and EN2 are generated according to the timing signals SR63 and SR64 informing bus buffer 35 to activate the specific groups of data buses. The enable signals EN1 and EN2 can also be generated by a counter which counts the time according to clock signal CLK and at least one predetermined value. In one embodiment, the bus buffer 35 does not require both enable signals. That is, since there are only two groups of data buses, one enable signal may be able to control the activation of both data buses. The bus buffer 35 is shown, herein, as being connected to two enable signals (i.e., EN1 and EN2) for illustrative purposes only.

Another embodiment is disclosed in FIG. 3B. This embodiment is a source driver including: a 128 bi-directional shift register 16D, a plurality of channel units 318A˜321A, a plurality of data buses 36A˜38A, 312A˜314A and a bus buffer 35A. The source driver further includes an input pad circuit 31A configured to accept color signals from an external source (e.g., a computer interface, a timing controller or a graphic card, etc.) and transport those signals to the source driver via data bus D0 32A, data bus D1 33A and data bus D2 34A. While dispatching of bus buffer 35A, each group of channel units is configured to receive image data from at least one specific data bus depending on the dispatching of bus buffer 35A. In this embodiment, the power consumed by the toggles of signals on the data bus can be significantly reduced.

The 128 bi-directional shift register 16D includes a plurality of bi-directional shift registers 322A˜325A, each triggered by clock signal CLK. A timing signal can be input from either IO port EIO 1(SR1) or IO port EIO 2. It should be appreciated that the, bi-directional shift registers are shown herein solely for illustrations purposes and should not be used to limit the numbers or types of shift registers available to the various embodiments of this invention. In one embodiment, the bi-directional shift register can be replaced by a unidirectional shift register if the source driver is not required to be bi-directional. Examples of bi-directional shift registers include, but are not limited to, flip flops, latches, etc. After receiving the timing signal, the bi-directional shift register 322A can pass timing signal SR2 to the next bi-directional shift register (not shown) in cascading fashion. In FIG. 3B, bi-directional shift register 323A and bi-directional shift register 324A are shown to receives timing signal SR63 and SR64,respectively for illustrative purposes only and should not be used to limit the scope of the various embodiments of this invention. Arbitrary groupings of channel units are also possible. Here, the bi-directional shift register 324A outputs timing signal SR65 to the next bi-directional shift register (not shown), and bi-directional shift register 325A receives timing signal SR128 and drives out that signal to IO port EIO 2 if there are other source driver ICs in the series.

Channel units (318A˜321A), data buses (D0 32A, D1 33A and D2 34A), bus buffer 35A and the plurality of data buses (36A˜38A and 312A˜314A) constitute line buffer 15D and can serve the same function the line buffer 15 in FIG. 1. Channel units 318A˜321A record their own image data from data buses 36A˜38A and 312A˜314A upon being triggered by the sequential outputs from the bi-directional shift registers. Channel units 318A˜321A further outputs recorded image data to level shifter 14 in FIG. 1. Bus buffer 35A is configured to group original image data buses D0 32A, D1 33A and D2 34A into six groups of image data buses 36A˜38A and 312A˜314A. Image data bus 36A can be dispatched to provide data transmission to channel unit 318A. Image data bus 37A can be dispatched to transmit data to channel units 318A and 319A. Image data bus 38A can be dispatched to transmit data to channel units 318A, 319A and 320A. It should be understood that the number of channel units that the data buses transmits data to were provided for illustrative purposes only in FIG. 3B. In practice, image data buses 36A˜38A can be dispatched to as few as three to as many as three hundred and eighty one channel units. The other groups of image data buses 312A˜314A can be dispatched to channel units that are complementary to those corresponding to image data buses 36A˜38A. That is, image data buses 312A˜314A can be dispatched to the rest of the three hundred and eighty four channels.

The management of the dispatching of the bus buffer 35A can be controlled by six enable signals (EN1˜EN6) corresponding to the activation of image data buses 36A˜38A and 312A˜314A, respectively. When enable signals EN1, EN2 and EN3 are active, the image data on the data buses D0 32A, D1 33A and D2 34A can be dispatched to image data buses 36A˜38A. Meanwhile, mage data buses 312A˜314A may be forced to be passive. When enable signals EN2, EN3 and EN4 are active, image data on data buses D0 32A, D1 33A and D2 34A can be dispatched to image data buses 312A, 37A and 38A. Meanwhile, the image data buses 36A, 313A and 314A may be forced to be passive. When enable signals EN3, EN4 and EN5 are active, the image data on data buses D0 32A, D1 33A and D2 34A can be dispatched to image data buses 312A, 313A and 38A. Meanwhile, image data buses 36A, 37A and 314A may be forced to be passive. When the enable signals EN4, EN5 and EN6 are active, the image data on data buses D0 32A, D1 33A and D2 34A can be dispatched to image data buses 312A, 313A and 314A. Meanwhile, image data buses 36A, 37A and 38A may be forced to be passive. Capacitors 39A, 310A and 311A represents parasitic capacitance created by the metal lines of data buses 36A˜38A, respectively. Capacitors 315A˜317A represents parasitic capacitance created by the metal lines of data buses 312A˜314A, respectively. Since the data buses are divided into six groups, the length of the metal lines can also be divided into segments and the parasitic capacitance may be significantly reduced.

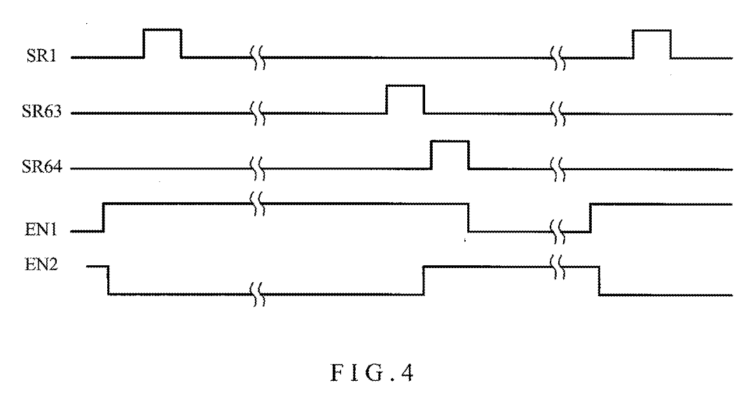

FIG. 4 is a diagram illustrating shifting signals from the bi-directional shift registers and control signals of a bus buffer according to the invention. Only the required timing signals SR1, SR63 and SR64, and enable signals EN1 and EN2 are shown herein. As discussed above, timing signals SR1, SR63 and SR64 are sequential signals. Once a timing event is triggered at IO port EIO 1 (SR1), a series of timing events can be generated between these cascading bi-directional shift registers. The high pulse of timing signal SR63 means that the triggering event has been delivered to the sixty third bi-directional shift register. Similarly, the high pulse of timing signal SR64 occurred at a time later than that of timing signal SR63. The two high pulses of the timing signal SR1 represents a complete cycle for each channel to grasp data from the image data buses. The two high pulses of timing signal SR1 also means the image data has finished being loaded during one of the scan events generated by gate drivers. The time scale has been omitted from FIG. 4 since no timing event occurs.

The enable signal EN1 goes into a high level covering timing events of timing signals SR1 and SR63. The timing events occur between the events of timing signals SR1 and SR63. Moreover, enable signal EN2 goes into a high level covering timing events of timing signals SR64 and SR128 (not shown). The timing events occur between the events of timing signals SR64 and SR128 (not shown). In one embodiment, a falling edge of enable signal EN1 is determined by timing signal SR64 and a rising edge of enable signal EN2 is determined by timing signal SR63. Therefore, it ensures that the switching overlap of enable signals of EN1 and EN2 are kept at a high level. If there is longer switching overlap required, a falling edge of enable signal EN1 can be determined by timing signal SR65 and a rising edge of the enable signal EN2 can be determined by timing signal SR62. When enable signal EN1 goes high, only data buses 36˜38 can be activated. Conversely, when enable signal EN2 goes high, only data buses 312˜314 can be activated. Thus, the capacitive loading of the chosen data buses are about half of what is found in the prior art. The capacitive loading of driven channels is also half compared to that in the prior art.

The waveforms shown in FIG. 4 are shown herein for illustrative purposes only. Several variations and modifications are possible. For example, one enable signal can control two groups of data buses. In one embodiment, a plurality of enable signals can be employed once there is a plurality of groups of data buses. In another embodiment, the grouping of data buses may be two groups with unequal numbers of buses. In yet another embodiment, the grouping of data buses depends upon the layout pattern on the silicon chip. Moreover, a plurality of bus buffers can be employed such that a complex management of data buses is possible.

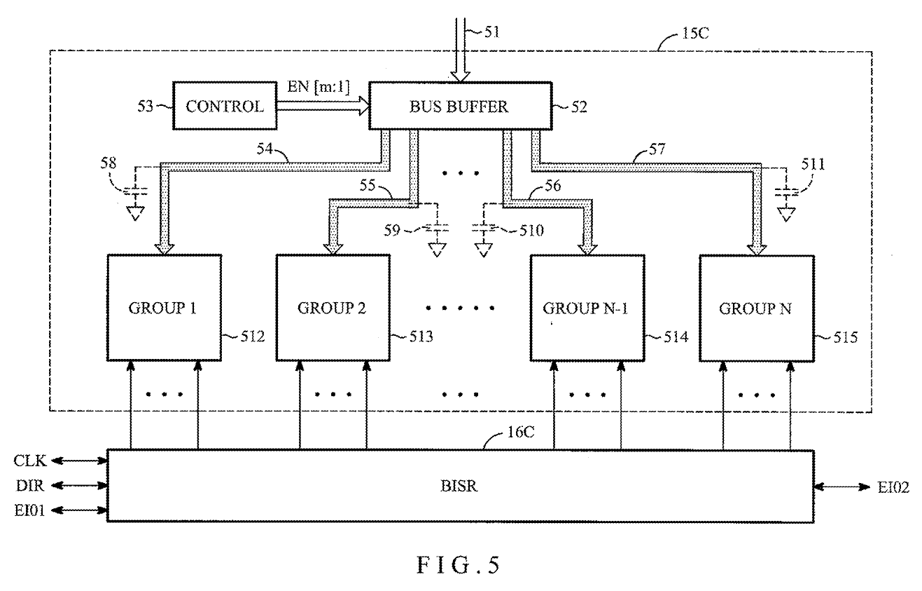

FIG. 5 is an embodiment utilizing a control circuit to dispatch data signals. As shown herein, a source driver with a plurality of channels includes: a bus buffer 52 receiving main image data bus 51 and controlling a plurality of data buses 54˜57, n number of groups of channels 512˜515 where n is an arbitrary integral number, a control circuit 53 outputting m number of enable signals EN[m:1] where m is an arbitrary integral number less than the number n, and a bi-directional shift register 16C outputting a number of outputs equal to or less than the number of channels in the source driver. Bus buffer 52, control circuit 53, groups of channels 512˜515 and multiple data buses 54˜57 constitutes line buffer 15C. The bi-directional shift register 16C can receive a clock signal CLK, a directional control signal DIR, IO port EIO 1 and IO port EIO 2. The IO ports EIO 1 and EIO 2 can be unidirectional or bi-directional depending on the requirements of the application. The number of channels for each group may be different. The grouping can rely on the driving ability of the channels or the architecture of circuits. Additionally, the grouping can depend upon the actual layout patterns or the actual layout locations of the circuits and data buses. Therefore, the parasitic capacitors (58, 59, 510 and 511) of data buses (54, 55, 56 and 57) have different capacitances from each other according to the driving ability, circuit architectures, layout patterns or layout locations of the circuit components on the source driver chip. Moreover, control circuit 53 outputs enable signal EN[m:1] and can receive timing information inputs from the timing signals generated by the bi-directional shift register 16C or from an embedded counter counting numbers that are synchronized to the clock signal CLK.

Although certain embodiments of the invention have been described in detail herein, it should be understood, by those of ordinary skill, that the invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the appended claims

What is claimed is:

1. A source driver for a display panel, comprising:
a D/A converter configured to convert image data on a plurality of channels to analog voltages for driving the display panel; and
a line buffer configured to receive the image data in sequence through an input terminal and having a plurality of channel units each temporally storing the image data on one of the channels so that the line buffer outputs the image data on the channels in parallel, wherein, the input terminal is alternately coupled to a first and second group of the channel units through a first and second group of buses.

2. The source driver according to claim 1, further comprising:
a bus buffer configured to regulate said image data of input terminal and dispatch to said first group of buses and said second group of buses according to a first and a second enable signals.

3. The source driver according to claim 1, wherein said line buffer has a plurality of channel units coupled with said buses for different colors.

4. The source driver according to claim 1, further comprising a plurality of gamma voltages coupled with said D/A converter indicating gray levels of a pixel.

5. The source driver according to claim 1, wherein said line buffer is further configured to receive outputs from a plurality of shift registers sequentially in time scale.

6. The source driver according to claim 1, wherein each of said plurality of channel units comprises at least one register being able to keep image data temporarily.

7. The source driver according to claim 1, wherein said buses comprises a red data bus, a green data bus and a blue data bus.

8. The source driver according to claim 2, wherein said bus buffer comprises at least one multiplexer.

9. The source driver according to claim 2, wherein said bus buffer comprises at least one tri-state buffer.

10. The source driver according to claim 2, wherein said bus buffer comprises at least one NAND logic circuit and one inverter.

11. The source driver according to claim 2, wherein said bus buffer is further configured to drive said first and said second group of buses separately.

12. The source driver according to claim 2, wherein said bus buffer is further configured to select which group of buses to drive according to at least one enable signal.

13. The source driver according to claim 12, wherein said enable signal is determined according to at least one timing signal generated by said shift registers.

14. The source driver according to claim 12, wherein said enable signal is determined according to a counter triggered by a clock signal.
